(19) United States
(12) Patent Application Publication
(10) Pub. No.: US 2024/0305103 A1
(43) Pub. Date: Sep. 12, 2024

(54) POWER SUPPLY SYSTEM AND POWER SUPPLY METHOD

(71) Applicant: Ace Power and Technology Co.,Ltd, Shanghai (CN)

(72) Inventor: Yuetian WANG, Shanghai (CN)

(21) Appl. No.: 18/027,332

(22) PCT Filed: Jun. 10, 2022
(86) PCT No.: PCT/CN2022/098125

§ 371 Date: Mar. 20, 2023

(30) Foreign Application Priority Data
Dec. 3, 2021 (CN) 202111470892.8

(51) Int. Cl. H02J 3/38; H01F 27/29; H02J 3/36; H02M 5/10

(52) U.S. Cl. CPC H02J 3/38; H01F 27/29; H02J 3/36; H02M 5/10

(57) ABSTRACT

The present disclosure provides a power supply system and a power supply method, which can be applied to the field of power distribution technologies. The power supply system comprises: a DC rectifying device, an industrial frequency transformer and at least two power supply devices, wherein the industrial frequency transformer is connected between the power supply device and the DC rectifying device, and the DC rectifying device is further connected to a load. The power supply system and the power supply method according to the embodiments of the present disclosure reduce the development cost and the development period of the power supply system.

### TECHNICAL FIELD

The present disclosure relates to the field of power distribution technologies, and particularly, to a power supply system and a power supply method.

### BACKGROUND

As the core network center of the Internet technology, the data center has a large number of devices and needs to run continuously all day, thus consuming huge power. With the development of the new energy technology, more and more environmentally friendly and economical electric energy sources are available. For the purposes of energy saving, environmental protection and electricity cost saving, the existing power supply scheme of the data center introduces a variety of different types of power supply devices in addition to the traditional mains supply device.

In the existing power supply scheme of the data center, in order to supply the electric energy of a new energy device or an energy storage device to the data center, it is necessary to develop a special unidirectional or bidirectional DC/DC converter for converting a DC voltage of the new energy device or the energy storage device into a DC voltage (e.g., 270V/378V) required by the data center device. An output side of the unidirectional or bidirectional DC/DC converter is directly connected to an input side of the data center device. The electric energy of the new energy device, the electric energy of the energy storage device and the power grid are three different types of electric energy sources of the data center.

### SUMMARY

This scheme has the following disadvantages: it requires the special development of the unidirectional or bidirectional DC/DC device for electric energy conversion in order to provide the required DC voltage, which will greatly increase the development cost of the power supply system and prolong the development period.

The present disclosure provides a power supply system and a power supply method so as to at least solve the problems of the high development cost and the long development period of the power supply system in the prior art.

In an aspect, the present disclosure proposes a power supply system, comprising a DC rectifying device, an industrial frequency transformer and at least two power supply devices, wherein the industrial frequency transformer is connected between the power supply device and the DC rectifying device, and the DC rectifying device is further connected to a load.

Optionally, the power supply device comprises a power grid.

Optionally, the power supply device further comprises a new energy device and/or an energy storage device.

Optionally, the industrial frequency transformer is a multi-winding transformer with a plurality of terminals, and each of the power supply devices is connected to a different terminal among the plurality of terminals of the multi-winding transformer.

Optionally, the new energy device comprises a power generation device and a first inverter, a first end of the first inverter being connected to the power generation device, and a second end of the first inverter being connected to the industrial frequency transformer.

Optionally, the energy storage device comprises an energy storage means and a second inverter, a first end of the second inverter being connected to the energy storage means, and a second end of the second inverter being connected to the industrial frequency transformer.

Optionally, the power supply system further comprises a backup battery, which is connected to an output end of the DC rectifying device and further connected to the load.

Optionally, the load is a data center device.

In another aspect, the present disclosure proposes a power supply method, comprising: determining a current power supply source according to voltages supplied by at least two power supply devices, wherein the power supply source is one of the at least two power supply devices; wherein the industrial frequency transformer is connected between the at least two power supply devices and a DC rectifying device that is connected to a load; and transforming the voltage supplied by the power supply source and providing the transformed voltage to the DC rectifying device, so that the DC rectifying device converts an AC voltage into a DC voltage and provides the DC voltage to the load.

Optionally, in a case where the power supply device comprises a power grid, if the current power supply source is a power supply device other than the power grid, transforming the voltage supplied by the power supply source and providing the transformed voltage to the DC rectifying device comprises: transforming the voltage supplied by the power supply source and providing the transformed voltage to the DC rectifying device, or respectively to the DC rectifying device and the grid.

In the power supply system according to the embodiments of the present disclosure, an AC voltage output by each of the power supply devices is fed into the industrial frequency transformer, and an output end of the industrial frequency transformer is connected to the DC rectifying device, which converts the AC voltage into a DC voltage and outputs the DC voltage to the DC load, thereby enabling the plurality of power supply devices to supply power to the load. Since the industrial frequency transformer can adopt those commonly used in the market, compared with the existing power supply system with a plurality of power supply devices, it is unnecessary to specially develop a unidirectional or bidirectional DC/DC device for the power supply system with a plurality of power supply devices according to the embodiment of the present disclosure, thereby reducing the development cost and the development period of the power supply system.

### BRIEF DESCRIPTION OF THE DRAWINGS

In order to more clearly explain the technical solutions in embodiments of the present disclosure, the drawings required for describing the embodiments will be briefly introduced below. Obviously, the drawings in the following description just illustrate some embodiments of the present disclosure, and those of ordinary skills in the art can obtain other drawings from them without paying any creative effort. In the drawings,

FIG. 1 is a schematic structural diagram of a power supply system according to an embodiment of present disclosure.

FIG. 2 is a schematic structural diagram of a multi-winding transformer according to an embodiment of present disclosure.

FIG. 3 is a flowchart of a power supply method according to an embodiment of present disclosure.

### DETAILED DESCRIPTION OF THE PREFERRED EMBODIMENTS

In order that the objectives, technical solutions and advantages of the embodiments of the present disclosure are clearer, the embodiments of the present disclosure are further described in detail below with reference to the drawings. Here, the exemplary embodiments of the present disclosure and the description thereof are used to explain, rather than limiting the present disclosure. It should be noted that the embodiments of the present disclosure and the features in the embodiments can be combined with each other arbitrarily without conflict.

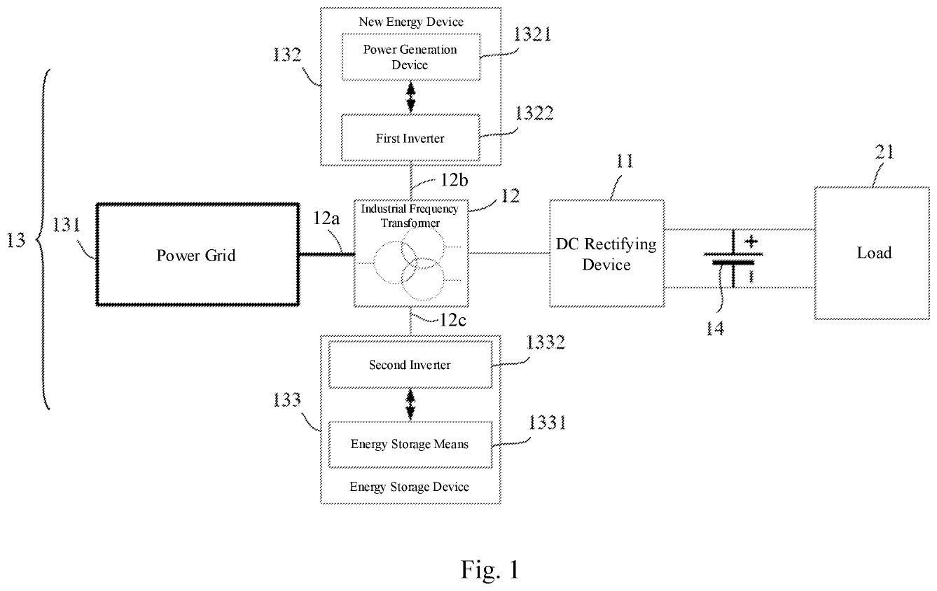

FIG. 1 is a schematic structural diagram of a power supply system according to an embodiment of present disclosure. As illustrated in FIG. 1, a power supply system according to an embodiment of the present disclosure includes a DC rectifying device 11, an industrial frequency transformer 12 and at least two power supply devices 13, wherein the industrial frequency transformer 12 is connected between the power supply device 13 and the DC rectifying device 11, and the DC rectifying device 11 is further connected to a load 21.

In this way, the power supply devices 13 provide different electric energy sources for the power supply system; for example, the power supply device includes a power grid, a new energy device, an energy storage device, etc. The industrial frequency transformer 12 converts the voltage supplied by each of the power supply devices 13. The DC rectifying device 11 converts an AC voltage output by the industrial frequency transformer 12 into a DC voltage required by the load 21, and the DC rectifying device 12 may be an isolated or non-isolated HVDC.

In the embodiment of the present disclosure, an AC voltage output by each of the power supply devices 13 is fed into the industrial frequency transformer 12, and an output end of the industrial frequency transformer 12 is connected to the DC rectifying device 11, which converts the AC voltage into a DC voltage and outputs the DC voltage to the DC load 21, thereby enabling the plurality of power supply devices 13 to supply power to the load 21. Since the industrial frequency transformer 12 can adopt those commonly used in the market, compared with the existing power supply system with a plurality of power supply devices, it is unnecessary to specially develop a unidirectional or bidirectional DC/DC device for the power supply system with a plurality of power supply devices according to the embodiment of the present disclosure, thereby reducing the development cost and the development period of the power supply system.

As illustrated in FIG. 1, optionally, the power supply device 13 may include a power grid 131, which provides a voltage of, for example, 10 KV, and an output end of the power grid 131 may be directly connected to the industrial frequency transformer 12.

As illustrated in FIG. 1, optionally, the power supply device 13 may further include a new energy device 132 and/or an energy storage device 133. The new energy device 132 may be a photovoltaic power generation device, a wind power generation device, etc., and the energy storage device 133 may be a battery, a super capacitor, etc.

As illustrated in FIG. 1, the industrial frequency transformer 12 may be a multi-winding transformer, and each of the power supply devices 13 is connected to a different terminal of the multi-winding transformer. It should be understood that FIG. 1 illustrates a schematic diagram of a connection relationship between the modularized power supply devices 13 and the modularized multi-winding transformer. As for the specific mode of the connection between the power supply devices 13 and the multi-winding transformer, for example, when one of the power supply devices 13 is a three-phase AC power source, a star connection (Y type) or a delta connection may be adopted between the multi-winding transformer and the power supply device 13; or, two ends of one of windings of the multi-winding transformer are respectively connected to a zero line of the power supply device 13 and one of three live lines thereof.

In this way, the multi-winding transformer can respectively supply the energy of the plurality of power supply devices 13 to the DC rectifying device 11, thereby supplying power to the DC load 21. When the plurality of power supply devices 13 include the power grid 131, the multi-winding transformer may further feed the energy of other power supply devices 13 (e.g., the new energy device 132 and the energy storage device 133) back to the power grid 131, thereby realizing a grid-connection function.

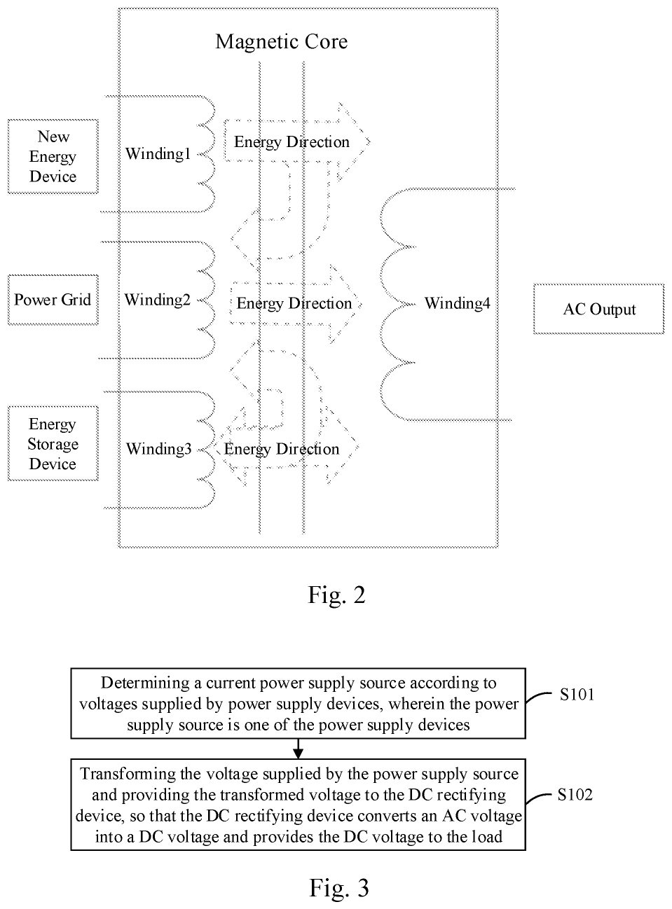

FIG. 2 depicts an internal structure of the multi-winding transformer and a direction of energy transfer. As illustrated in FIG. 2, a power grid, a new energy device, an energy storage device and an AC output side are respectively connected to one winding of the multi-winding transformer. The three power supply devices supply power in a time-sharing manner, so that a plurality of windings in the multi-winding transformer can share one magnetic core, and the energy of the transformer is fully utilized. Compared with the power supply system with a plurality of industrial frequency transformers, the usage amount of the industrial frequency transformers can be decreased and the cost is greatly decreased reduced. In addition, the multi-winding transformer may feed the energy of the new energy device and the energy storage device back to the power grid to realize the grid-connection function, or supply the energy of the new energy device and the energy storage device to the DC rectifying device to supply power to the load. This configuration solution allows the existing multi-winding transformer to be used, and other devices may also adopt the existing commercial devices without increasing the development cost, thereby further reducing the cost and making the whole power supply system be simpler and more efficient (see FIG. 1).

As illustrated in FIG. 1, optionally, the new energy device 132 may include a power generation device 1321 and a first inverter 1322, wherein a first end of the first inverter 1322 is connected to the power generation device 1321, and a second end of the first inverter 1322 is connected to the industrial frequency transformer 12.

In this way, no dedicated DC/DC device is required to obtain a DC voltage. Instead, the first inverter 1322 in the new energy device 132 outputs an AC voltage, such as 380V AC voltage, and the output AC voltage is transferred to the industrial frequency transformer 12, an output end of which is connected to an output side of the power grid 131 or directly connected to the DC rectifying device 11, so that the new energy device 132 supplies electric energy to the post load 21.

When the electric energy generated by the new energy device 132 is large enough (e.g., under good illumination conditions, sufficient wind energy, etc.), the generated electric energy may be supplied to the post load 21, and the redundant electric energy may be fed back to the power grid 131 through the industrial frequency transformer 12 by increasing the amplitude of the AC voltage output by the first inverter 1322, thereby further reducing the electricity cost.

Optionally, in the above embodiment, when the new energy device 132 is a photovoltaic power generation device, the first inverter 1322 may be a Photovoltaic Inverter (PVI).

As illustrated in FIG. 1, optionally, the energy storage device 133 includes an energy storage means 1331 and a second inverter 1332, wherein a first end of the second inverter 1332 is connected to the energy storage means 1331, and a second end of the second inverter 1332 is connected to the industrial frequency transformer 12.

In this way, no dedicated DC/DC device is required to obtain a DC voltage. Instead, the second inverter 1332 in the energy storage device 133 outputs an AC voltage, such as 380V AC voltage, and the output AC voltage is transferred to the industrial frequency transformer 12. The second inverter 1332 may be a Power Conversion System (PCS) inverter.

As illustrated in FIGS. 1 and 2, when the power supply device 13 includes the power grid 131, the new energy device 132, and the energy storage device 133, the new energy device 132 and the energy storage device 133 output AC voltages through their respective inverters, and supply the AC voltages to the industrial frequency transformer 12.

As illustrated in FIG. 1, optionally, the power supply system may further include a backup battery 14, which is connected to the output end of the DC rectifying device 11 and further connected to the load 21.

In this way, the backup battery 14 may be connected to the output end of the DC rectifying device 11. When the DC rectifying device 11 continuously outputs electric energy, the backup battery 14 is continuously charged to maintain a fully charged state. When the DC rectifying device 11 is powered off, the backup battery 14 serves as a reserve power source to supply power to the load 21.

As illustrated in FIG. 1, optionally, the load 21 may be a data center device, which requires a DC voltage of 270 V/378 V. The AC voltage output by the industrial frequency transformer 12 to the DC rectifying device 11 may be 380 V, and the DC rectifying device 11 may convert the AC voltage of 380 V to the DC voltage of 270 V/378 V.

FIG. 3 is a flowchart of a power supply method according to an embodiment of present disclosure. As illustrated in FIG. 3, a power supply method according to an embodiment of the present disclosure is based on the power supply system according to any of the above embodiments, and is specifically applicable to the industrial frequency transformer. The method includes:

S101: determining a current power supply source according to voltages supplied by at least two power supply devices, wherein the power supply source is one of the at least two power supply devices; wherein the industrial frequency transformer is connected between the at least two power supply devices and a DC rectifying device that is connected to a load.

In step S101, all or part of the power supply devices may be connected to the industrial frequency transformer. At this time, the voltage supplied by a power supply device not connected to the industrial frequency transformer is 0 V; and a power supply device with the highest voltage amplitude among the AC voltages supplied by the power supply devices is the current power supply source. Specifically, the industrial frequency transformer may be a multi-winding transformer, and each of the power supply devices is connected to one of the terminals of the multi-winding transformer. The multi-winding transformer may determine the current power supply source according to the voltages supplied by the power supply devices, so as to realize the time-sharing power supply of the power supply devices.

S102: transforming the voltage supplied by the power supply source and providing the transformed voltage to the DC rectifying device, so that the DC rectifying device converts an AC voltage into a DC voltage and provides the DC voltage to the load.

In step S102, the industrial frequency transformer transforms the voltage supplied by the power supply source and provides the transformed voltage to the DC rectifying device. Next, the DC rectifying device converts an AV voltage output by the industrial frequency transformer into a DC voltage and provides the DC voltage to the load.

In the power supply method according to the embodiment of the present disclosure, the AC voltage output by each of the power supply devices is transferred to the industrial frequency transformer. The industrial frequency transformer determines a current power supply source according to the voltage supplied by each of the power supply devices, transforms the voltage supplied by the current power supply source and provides the transformed voltage to the DC rectifying device. The DC rectifying device converts an AC voltage output by the industrial frequency transformer into a DC voltage and outputs the DC voltage to a DC load, so that the load is powered by the plurality of power supply devices. Since the industrial frequency transformer can adopt those commonly used in the market, compared with the existing power supply system with a plurality of power supply devices, it is unnecessary to specially develop a unidirectional or bidirectional DC/DC device for the power supply system with a plurality of power supply devices according to the embodiment of the present disclosure, thereby reducing the development cost and the development period of the power supply system.

Optionally, in a case where the power supply device includes a power grid, if the current power supply source is a power supply device other than the power grid, transforming the voltage supplied by the power supply source and providing the transformed voltage to the DC rectifying device includes: transforming the voltage supplied by the power supply source and providing the transformed voltage to the DC rectifying device, or respectively to the DC rectifying device and the grid.

In this way, if the current power supply source is a power supply device other than the power grid, such as a new energy device, the industrial frequency transformer can distribute the electric energy of the power supply source to the load connected to the DC rectifying device and the grid at the same time.

For example, FIG. 2 depicts an internal structure of an industrial frequency transformer (multi-winding transformer) and a direction of energy transfer. As illustrated in FIG. 2, a power grid, a new energy device 132, an energy storage device 133 and an AC output side are respectively connected to one winding of the multi-winding transformer. The three power supply devices supply power in a time-sharing manner, so that the multi-winding transformer can feed the energy of the new energy device 132 and the energy storage device 133 to the grid 131 to realize the grid-connection function, or supply the energy of the new energy device 132 and the energy storage device 133 to the DC rectifying device 11 to supply power to the load 21. This configuration solution allows the existing multi-winding transformer to be used, and other devices may also adopt the existing commercial devices without increasing the development cost, thereby further reducing the cost and making the whole power supply system be simpler and more efficient (see FIG. 1).

In the present disclosure, descriptions referring to the terms such as ‘an embodiment’, ‘a specific embodiment’, ‘some embodiments’, ‘for example’, ‘an example’, ‘a specific example’ or ‘some examples’ mean that the specific features, structures, materials or characteristics described in connection with the embodiment(s) or example(s) are included in at least one embodiment or example of the present disclosure. In the present disclosure, the schematic expressions of the above terms do not necessarily refer to a same embodiment or example. Further, the specific features, structures, materials or characteristics described may be combined in any one or more embodiments or examples in a suitable manner.

The above specific embodiments further explain the objectives, technical solutions and advantageous effects of the present disclosure in detail. It should be understood that those described above are only specific embodiments of the present disclosure, and are not intended to limit the protection scope of the present disclosure. Any modification, equivalent substitution, improvement, etc. made within the spirit and principle of the present disclosure should fall within the protection scope of the present disclosure.

What is claimed is:

1. A power supply system, comprising a DC rectifying device, an industrial frequency transformer and at least two power supply devices, wherein
the industrial frequency transformer is connected between the power supply device and the DC rectifying device, and the DC rectifying device is further connected to a load.

2. The power supply system according to claim 1, wherein the industrial frequency transformer is a multi-winding transformer with a plurality of terminals, and each of the power supply devices is connected to a different terminal among the plurality of terminals of the multi-winding transformer.

3. The power supply system according to claim 2, wherein the power supply device comprises a power grid.

4. The power supply system according to claim 3, wherein the power supply device further comprises a new energy device and/or an energy storage device.

5. The power supply system according to claim 4, wherein the new energy device comprises a power generation device and a first inverter, a first end of the first inverter being connected to the power generation device, and a second end of the first inverter being connected to the industrial frequency transformer.

6. The power supply system according to claim 4, wherein the energy storage device comprises an energy storage means and a second inverter, a first end of the second inverter being connected to the energy storage means, and a second end of the second inverter being connected to the industrial frequency transformer.

7. The power supply system according to claim 3, wherein the power supply system further comprises a backup battery, which is connected to an output end of the DC rectifying device and further connected to the load.

8. The power supply system according to claim 3, wherein the load is a data center device.

9. A power supply method, comprising:
determining a current power supply source according to voltages supplied by at least two power supply devices, wherein the power supply source is one of the at least two power supply devices; wherein the industrial frequency transformer is connected between the at least two power supply devices and a DC rectifying device that is connected to a load;
transforming the voltage supplied by the power supply source and providing the transformed voltage to the DC rectifying device, so that the DC rectifying device converts an AC voltage into a DC voltage and provides the DC voltage to the load.

10. The method according to claim 9, wherein in a case where the power supply device comprises a power grid, if the current power supply source is a power supply device other than the power grid, transforming the voltage supplied by the power supply source and providing the transformed voltage to the DC rectifying device comprises:
transforming the voltage supplied by the power supply source and providing the transformed voltage to the DC rectifying device, or respectively to the DC rectifying device and the grid.
